(19) United States
(12) Patent Application Publication
(10) Pub. No.: US 2022/0088904 A1
(43) Pub. Date: Mar. 24, 2022

(54) GLASS LAMINATE ARTICLE AND METHOD OF MANUFACTURING THE SAME

(71) Applicant: Corning Incorporated, Corning, NY (US)

(72) Inventors: Cheol Hee Park, Asan-si (KR); Seung-yong Park, Asan-si (KR); Dong Keun Shin, Hwasung-si (KR)

(21) Appl. No.: 17/420,860

(22) PCT Filed: Jan. 6, 2020
(86) PCT No.: PCT/KR2020/000209

§ 371 Date: Jul. 6, 2021

(30) Foreign Application Priority Data
Jan. 8, 2019 (KR) 10-2019-0002396

(51) Int. Cl. B32B 17/10; B32B 7/12; C03B 33/033; C03C 27/04; B32B 3/26; B32B 38/00; C03B 33/07; C03C 19/00

(52) U.S. Cl. CPC B32B 17/10155; B32B 7/12; B32B 17/10935; B32B 17/1099; C03B 33/033; C03C 19/00; B32B 17/10036; C03C 27/04; B32B 3/263; B32B 38/105; C03B 33/076; B32B 17/10568

(57) ABSTRACT

A glass laminate article includes an adhesive film attached to a base material, and a glass substrate layer attached to the adhesive film, wherein the glass substrate layer has a side surface that is inclined with respect to an upper surface thereof by an obtuse angle. According to the glass laminate article and a method of manufacturing the glass laminate article, the glass laminate article has an excellent appearance and safety and may be easily manufactured at a low cost.

### CROSS-REFERENCE TO RELATED APPLICATION

This application claims the benefit of priority under 35 U.S.C. § 119 of Korean

Patent Application Serial No. 10-2019-0002396, filed on Jan. 8, 2019, in the Korean Intellectual Property Office, the disclosure of which is incorporated herein in its entirety by reference.

### TECHNICAL FIELD

### Field

One or more embodiments relate to a glass laminate article and a method of manufacturing the glass laminate article, and more particularly, to a glass laminate article having an excellent appearance and safety and a method of manufacturing the glass laminate article easily at a low cost.

### BACKGROUND ART

A glass laminate article has an excellent appearance and is easy to clean, and thus may be applied to various purposes. For example, a glass laminate article may be applied to wall panels, backsplashes, the exterior of cabinets or furniture, the exterior of home appliances, or other construction applications. Therefore, there is a need for a method of manufacturing a glass thin film on a base material aesthetically while ensuring safety.

### DISCLOSURE OF INVENTION

### Technical Problem

One or more embodiments include a glass laminate article having an excellent appearance and safety.

One or more embodiments include a method of manufacturing a glass laminate article having an excellent appearance and safety, at a low cost.

### Solution to Problem

Additional aspects will be set forth in part in the description which follows and, in part, will be apparent from the description, or may be learned by practice of the presented embodiments.

According to one or more embodiments, a glass laminate article includes an adhesive film attached to a base material, and a glass substrate layer attached to the adhesive film, wherein the glass substrate layer has a side surface that is inclined with respect to an upper surface thereof by an obtuse angle.

The base material may include a first side surface that is substantially perpendicular to the upper surface of the base material, and a second side surface that is in parallel with the side surface of the glass substrate layer and is adjacent to the first side surface.

In some embodiments, the second side surface may be inclined with the upper surface of the base material by about 95° to about 120°. In some embodiments, a distance between an end portion of the upper surface of the glass substrate layer and the first side surface in a direction parallel with the upper surface of the glass substrate layer may be about 0.5 mm or less.

In some embodiments, a side surface of the adhesive film may be flush and continuous with the side surface of the glass substrate layer. In some embodiments, the side surface of the glass substrate layer, the side surface of the adhesive film, and the second side surface may be successively adjacent to one another in the stated order and are flush with one another.

In some embodiments, the base material may include a metal base material stacked on a non-metal base material and the metal base material may be in contact with the adhesive film.

According to one or more embodiments, a method of manufacturing a glass laminate article, the method includes: attaching an adhesive film to a base material; attaching a glass substrate layer to the adhesive film so as to have an overhang region beyond an edge of the base material; performing a scoring within the overhang region of the glass substrate layer; removing the overhang region at an outer portion of a scoring portion in the glass substrate layer; and finishing a remaining overhang region of the glass substrate layer.

In some embodiments, a length of a protruding portion of the overhang region over the edges of the base material may be about 3 mm to about 15 mm. In some embodiments, in the performing of the scoring, a distance between the edge of the base material and the scoring line may be about 1 mm or less. In some embodiments, in the scoring, the distance between the edges of the base material and the scoring line may be about 0.2 mm to about 0.5 mm, respectively.

In some embodiments, the scoring may include providing a supporter under the overhang region before scoring the glass substrate layer.

In some embodiments, the finishing of the remaining overhang region may include removing the remaining overhang region by a grinding method. In some embodiments, the finishing may be performed such that a side surface of the glass substrate layer is made to have an angle of about 95° to about 120° with respect to an upper surface of the glass substrate layer.

In some embodiments, the method may further include cooling down the scoring line in the glass substrate layer to a temperature of 0° C. or less before the removing of the overhang region. The cooling down of the scoring line may include spraying nitrogen.

### BRIEF DESCRIPTION OF DRAWINGS

These and/or other aspects will become apparent and more readily appreciated from the following description of the embodiments, taken in conjunction with the accompanying drawings in which:

FIG. 1 is a cross-sectional view of a glass laminate article according to an embodiment;

FIG. 2 is an enlarged cross-sectional view of region II in FIG. 1;

FIG. 3 is a flowchart of a method of manufacturing a glass laminate article according to an embodiment;

FIGS. 4A to 4E are side cross-sectional views illustrating a method of manufacturing a glass laminate article according to an embodiment;

FIG. 5 is a partially enlarged view of region V of FIG. 4B in detail;

FIG. 6 is a partially enlarged view of region VI of FIG. 4C in detail; and

FIG. 7 is a cross-sectional view showing an edge of a glass laminate article according to another embodiment.

### BEST MODE FOR CARRYING OUT THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, one or more embodiments of the present disclosure will be described in detail with reference to accompanying drawings. Various modifications, additions and substitutions of the embodiment of the present disclosure are possible, and thus it will be appreciated that the present disclosure is not limited to the following embodiments. The embodiments of the present disclosure are provided so that this disclosure will be thorough and complete, and will fully convey the concept of the present disclosure to one of ordinary skill in the art. Like reference numerals may denote like elements throughout the specification. Moreover, various elements and regions in the drawings are schematically illustrated. Accordingly, the disclosure is not limited by relative sizes or intervals illustrated in the attached drawings.

It will be understood that although the terms “first,” “second,” etc. may be used herein to describe various components, these components should not be limited by these terms. Terms are only used to distinguish one element from other elements. For example, a first component may be referred to as a second component and vice versa, without departing from the scope of the present disclosure.

The terms used in the present specification are merely used to describe particular embodiments, and are not intended to limit the present disclosure. An expression used in the singular encompasses the expression of the plural, unless it has a clearly different meaning in the context. In the present specification, it will be understood that the terms “comprises” or “comprising,” when used in this specification, specify the presence of stated features, number, steps, operations, elements, components, and groups thereof, but do not preclude the presence or addition of one or more other features, number, steps, operations, elements, components, or groups thereof.

Unless otherwise defined, all terms used herein and including technical and scientific terms have the same meaning as those generally understood by one of ordinary skill in the art. Also, terms defined in commonly used dictionaries should be interpreted as having the same meanings as those in the context of related technologies, and unless clearly defined, are not interpreted as ideally or excessively formal meanings.

When a certain embodiment may be implemented differently, a specific process order may be performed differently from the described order. For example, two consecutively described processes may be performed substantially at the same time or performed in an order opposite to the described order.

In the drawings, for example, according to the manufacturing technology and/or tolerance, variations from the illustrated shape may be expected. Thus, the embodiments of the present disclosure must not be interpreted to be limited by a particular shape that is illustrated in the drawings and must include a change in the shape occurring, for example, during manufacturing. As used herein, “and/or” includes each and at least one all combinations of the mentioned items. Also, the term “base material” used herein may denote the base material itself, or a stack structure including a base material and a predetermined layer or film formed on the base material. Also, “surface of a base material” used herein may denote an exposed surface of the base material itself, or an outer surface of a predetermined layer or film formed on the base material.

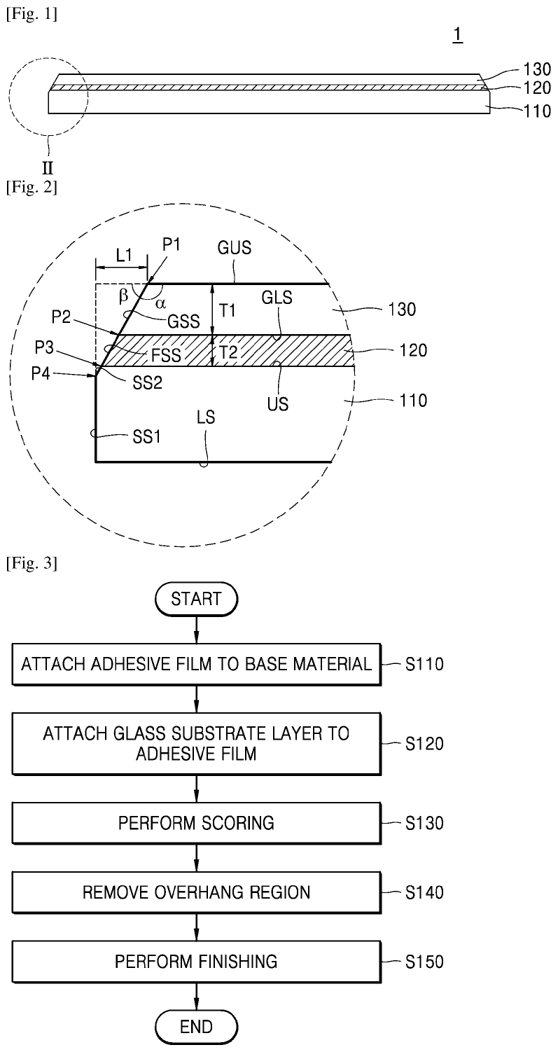

FIG. 1 is a cross-sectional view of a glass laminate article 1 according to an embodiment.

Referring to FIG. 1, the glass laminate article 1 includes an adhesive film 120 attached to a base material 110, and a glass substrate layer 130 attached to the adhesive film 120.

The base material 110 may include, for example, a metal substrate, a wooden substrate, an inorganic substrate, an organic substrate, or a composite material thereof. The base material 110 may include, but is not limited to, one selected from steel, stainless steel, aluminum, copper, other metal alloys, polymers, pulp, paper, and composites thereof.

In some embodiments, the base material 110 may be obtained by coating the metal substrate, the wooden substrate, the inorganic substrate, the organic substrate, or a composite material thereof with an organic film. In some embodiments, the base material 110 may be obtained by coating the metal substrate, the wooden substrate, the inorganic substrate, the organic substrate, or a composite material thereof with a paint.

In some embodiments, the base material 110 may include a high-pressure laminate (HPL), a paint-coated metal (PCM), a medium density fiberboard (MDF), or a vinyl-coated metal (VCM). In some embodiments, the base material 110 may be used in wall panels, backsplash, the exterior of a cabinet or furniture, the exterior of home appliances, marker boards, or other construction applications.

The glass substrate layer 130 may include a glass material containing about 30 mol % to about 85 mol % SiO₂, about 1 mol % to about 25 mol % Al₂O₃, about 0.1 mol % to about 15 mol % B₂O₃, about 0.1 mol % to about 10 mol % MgO, and about 0.1 mol % to about 10 mol % CaO. In some embodiments, the glass substrate layer 130 may further include, but is not limited to, Li₂O, K₂O, ZnO, SrO, BaO, SnO₂, TiO₂, V₂O₃, Nb₂O₅, MnO, ZrO₂, As₂O₃, MoO₃, Sb₂O₃, and/or CeO₂.

The glass substrate layer 130 may have a thickness T1 of about 50 μm to about 500 μm. In some embodiments, the glass substrate layer 130 may have a thickness T1 of about 80 μm to about 400 μm, about 100 μm to about 350 μm, about 120 μm to about 300 μm, or about 150 μm to about 250 μm. When the glass substrate layer 130 is excessively thick, the glass substrate layer 130 may be easily detached due to the weight and may have an inferior adaptability with respect to a curved surface. When the glass substrate layer 130 is excessively thin, the glass substrate layer 130 may have an insufficient strength.

In some embodiments, the glass substrate layer 130 may have a transmittance of about 90% or greater with respect to visible light. In some embodiment, the glass substrate layer 130 may have a transmittance of about 93% or greater, about 95% or greater, about 96% or greater, about 97% or greater, about 98% or greater, and about 99% or greater with respect to the visible light.

The adhesive film 120 may have adhering force on both of upper and lower surfaces thereof. For example, the adhesive film 120 may include a pressure sensitive adhesive (PSA) such as acryl-based, silicon-based, urethane-based, rubber-based, vinyl ether-based adhesive, etc., or an optically clear adhesive (OCA). However, one or more embodiments are not limited thereto.

When the base material 110 and the glass substrate layer 130 are adhered to each other via a liquid type adhesive, an inferior safety may be obtained as compared with a case in which the base material 110 and the glass substrate layer 130 are attached to each other via the adhesive film 120. That is, when the base material 110 and the glass substrate layer 130 are adhered to each other via the adhesive film 120, even if the glass substrate layer 130 breaks, most of shards remains as fixed by the adhesive film 120. However, when the base material 110 and the glass substrate layer 130 are adhered to each other via the liquid type adhesive, the liquid type adhesive is hardened as a solid. Then, when the glass substrate layer 130 breaks, shards of the glass substrate layer 130 are isolated and scattered from the base material 110, which may cause a safety issue.

The adhesive film 120 may have a thickness T2 of about 20 μm to about 150 μm. In some embodiments, the adhesive film 120 may have a thickness T2 of about 30 μm to about 130 μm, about 50 μm to about 120 μm, or about 70 μm to about 100 μm.

FIG. 2 is an enlarged cross-sectional view of a region II in FIG. 1.

Referring to FIG. 2, a side surface GSS of the glass substrate layer 130 may be inclined with respect to an upper surface GUS of the glass substrate layer 130 by an obtuse angle α. The obtuse angle may be about 95° to about 120°. A supplementary angle β of the obtuse angle α may be about 60° to about 85°.

A side surface FSS of the adhesive film 120 may be also inclined with respect to the upper surface GUS of the glass substrate layer 130 by a predetermined angle. In some embodiments, the side surface FSS of the adhesive film 120 may be in parallel with the side surface GSS of the glass substrate layer 130. In some embodiments, the side surface FSS of the adhesive film 120 may be substantially flush with the side surface GSS of the glass substrate layer 130.

The base material 110 may have a first side surface SS1 and a second side surface SS2 between an upper surface US and a lower surface LS thereof. The first side surface SS1 and the second side surface SS2 may be planes that are adjacent to and different from each other.

The first side surface SS1 may be substantially perpendicular to the upper surface US and/or the lower surface LS. The second side surface SS2 may be inclined with regard to the upper surface US of the base material 110 by an angle of about 95° to about 120°. In other words, an angle of about 60° to about 85° may be formed between the second side surface SS2 and an extending plane from the upper surface US of the base material 110.

When the obtuse angle α is excessively large, a distance L1 increases and a bad appearance may be obtained, and when the obtuse angle α is too small, the distance L1 decreases and a size of a product may be unintentionally reduced during manufacturing processes.

Here, each of the first side surface SS1 and the second side surface SS2 of the base material 110, the side surface FSS of the adhesive film 120, and the side surface GSS and the upper surface GUS of the glass substrate layer 130 may not be necessarily a plane, that is, one or more of the above surfaces may be a curved surface. An angle at an intersection between two curved surfaces may be an angle between tangents of the curved surfaces at the intersection.

The glass substrate layer 130 may have a first point P1 at a point where the upper surface GUS and the side surface GSS intersect with each other. In addition, the glass substrate layer 130 may have a second point P2 at a point where the lower surface GLS and the side surface GSS intersect with each other. The base material 110 may have a third point P3 at a point where the upper surface US and the second side surface SS2 intersect with each other. In addition, the base material 110 may have a fourth point P4 at a point where the first side surface SS1 and the second side surface SS2 intersect with each other.

In some embodiments, a straight line connecting the first point P1 and the second point P2 may be substantially in parallel with a straight line connecting the third point P3 and the fourth point P4. In some embodiments, a straight line connecting the first point P1 and the second point P2 may be substantially the same as a straight line connecting the third point P3 and the fourth point P4.

In some embodiments, the side surface GSS between the first point P1 and the second point P2 may smoothly continue to the side surface FSS between the second point P2 and the third point P3 at the second point P2. In some embodiments, the side surface FSS between the second point P2 and the third point P3 may smoothly continue to the second side surface SS2 between the third point P3 and the fourth point P4 at the third point P3. Here, that the two surfaces smoothly continue to each other at a contact point between the surfaces may denote that an inclination of a tangent at each point on the two surfaces gradually changes as going from one surface to another surface along the surfaces.

The distance L1 between the first point P1 that is an end of the upper surface GUS of the glass substrate layer 130 and the first side surface SS1 in a direction in parallel with the upper surface GUS of the glass substrate layer 130 is about 0.5 mm or less or about 0.2 mm or less, e.g., may be in a range between about 0.2 mm (that is, 200 μm) to about 0.5 mm (that is, 500 μm) or between 0 mm and 0.2 mm. When the distance L1 is excessively large, a gap between two glass laminate articles is large and the large gap deteriorates the external appearance when the two or more glass laminate articles that are final products are successively attached to one another.

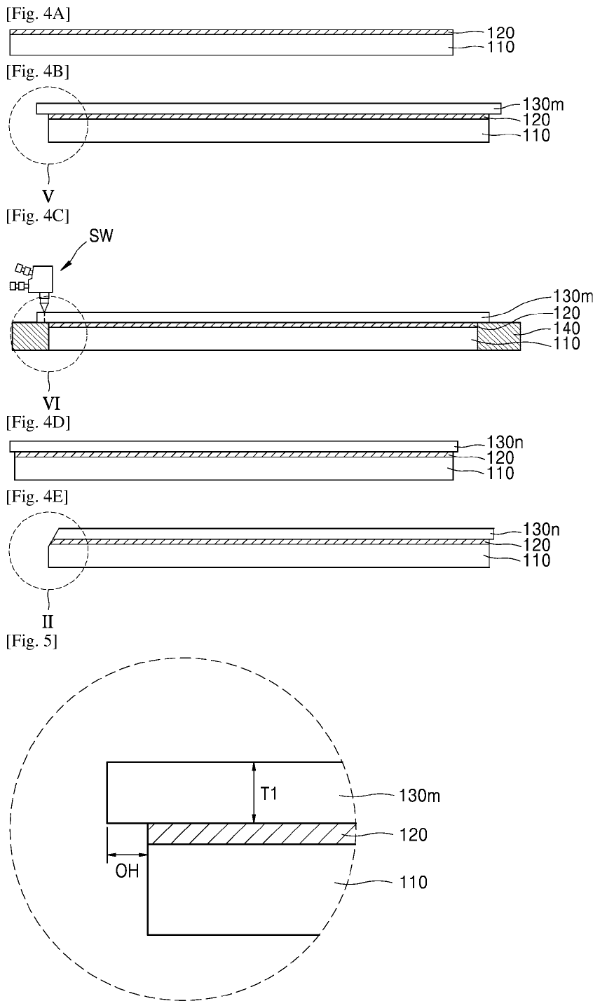

FIG. 3 is a flowchart of a method of manufacturing a glass laminate article 1 according to an embodiment. FIGS. 4A to 4E are side sectional views illustrating a method of manufacturing the glass laminate article 1 according to an embodiment.

Referring to FIG. 3 and FIG. 4A, the adhesive film 120 may be attached to the base material 110 (S110). The base material 110 and the adhesive film 120 are described above with reference to FIGS. 1 and 2, and thus detailed descriptions thereof are omitted.

Referring to FIGS. 3 and 4B, a glass substrate layer 130m may be attached to the adhesive film 120 (S120). Here, edges of the glass substrate layer 130m may protrude further in a lateral direction than the base material 110 and the adhesive film 120, and may form an overhang region. In FIG. 4B, the overhang region protrudes in left and right directions of the base material 110 and the adhesive film 120, but the overhang region may protrude along circumferences of the base material 110 and the adhesive film 120.

FIG. 5 is a partially enlarged view of a region V of FIG. 4B in detail.

Referring to FIG. 5, the edge of the glass substrate layer 130m protrudes from the edges of the base material 110 and the adhesive film 120 in the lateral direction as much as a width OH of the overhang region. The width OH of the overhang region may be about 3 mm to about 15 mm. When the width OH of the overhang region is excessively large, the glass substrate layer 130m may break while being attached to the adhesive film 120. Alternatively, when the width OH of the overhang region is too small, there may be an issue during a scoring process that will be performed later.

Referring to FIGS. 3 and 4C, a scoring may be performed on the overhang region of the glass substrate layer 130m (S130). The scoring may be performed by forming a recess of a predetermined depth in the glass substrate layer 130m to extend as a line shape by using a scoring wheel SW. In FIG. 4C, the scoring wheel SW may score the glass substrate layer 130m while moving away (or approaching) along a line of sight direction. As a result, the recess (that is, scoring line) extending in the sight direction may be formed.

The scoring may be performed on entire overhang region along the circumference of the base material 110. For example, when the base material 110 has a square planar shape and the glass substrate layer 130m has the overhang region protruding from every side of the square planar shape, the scoring may be performed along each side of the square planar shape.

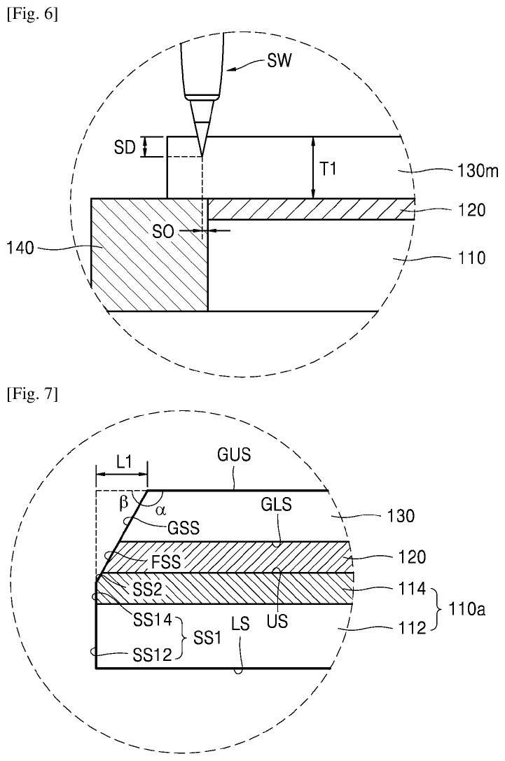

FIG. 6 is a partially enlarged view of a region VI of FIG. 4C in detail.

Referring to FIG. 6, the recess formed by the scoring operation may be formed between the edge of the glass substrate layer 130m and the edge of the base material 110. In some embodiments, the recess may be formed close to the edge of the base material 110.

For example, a distance SO between the edge of the base material 110 and the scoring line may be about 1 mm or less, about 0.9 mm or less, about 0.8 mm or less, about 0.7 mm or less, about 0.6 mm or less, or about 0.5 mm or less. When the distance SO between the edge of the base material 110 and the scoring line is excessively large, a portion of the glass substrate layer 130m, which has to be removed during a finishing process, increases, thereby degrading productivity.

In some embodiments, the distance SO between the edge of the base material 110 and the scoring line is about 0.1 mm or greater, about 0.2 mm or greater, about 0.3 mm or greater, about 0.4 mm or greater, or about 0.45 mm or greater. When the distance SO between the edge of the base material 110 and the scoring line is too small, a main portion of the glass substrate layer 130m may be affected, e.g., cracked, while the overhang region is removed.

The distance SO between the edge of the base material 110 and the scoring line may be determined based on a thickness, a physical property, etc. of the glass substrate layer 130m.

A depth SD of the scoring line may be, with respect to the thickness T1 of the glass substrate layer 130m, about 10% to about 35%, about 12% to about 34%, about 14% to about 33%, about 16% to about 32%, about 18% to about 31%, or about 20% to about 30%. If the depth SD of the scoring line is too shallow, isolation along the scoring line may not be clearly performed when the overhang region at an outer portion of the scoring portion is removed later. If the depth SD of the scoring line is too deep, the glass substrate layer 130m may be unintentionally damaged during the scoring process.

In some embodiments, a supporter 140 that may support the overhang region during the scoring process may be provided under the overhang region. When the distance SO between the edge of the base material 110 and the scoring line is relatively large, the glass substrate layer 130m may be damaged due to a pressure applied downward by the scoring wheel SW when the scoring process is performed.

However, when the distance SO between the edge of the base material 110 and the scoring line is relatively small within an allowable range, there is a low possibility of causing the above damage, and thus, the supporter 140 may not be necessary. The supporter 140 may be an arbitrary rigid body that may support the glass substrate layer 130m, and may include plastic, steel, wood, or a complex material thereof. However, one or more embodiments are not limited thereto.

FIG. 6 shows that the supporter 140 is arranged in a lateral direction of the base material 110, but in some other embodiments, the supporter 140 may be configured to accommodate the base material 110 while contacting the side surface and the lower surface of the base material 110.

Referring to FIGS. 3 and 4D, the overhang region of the glass substrate layer 130m, in particular, an outer portion of the scoring line, may be removed. As described above with reference to FIG. 4C, the scoring line may be formed so that the distance SO between the edge of the base material 110 and the scoring line may be about 1 mm or less, about 0.9 mm or less, about 0.8 mm or less, about 0.7 mm or less, about 0.6 mm or less, or about 0.5 mm or less. Therefore, when the outer portion of the scoring line is removed as shown in FIG. 4D, a protruding portion of a glass substrate layer 130n from the edge of the base material 110 (remaining overhang region) may have a length of about 1 mm or less, about 0.9 mm or less, about 0.8 mm or less, about 0.7 mm or less, about 0.6 mm or less, or about 0.5 mm or less.

The overhang region of the glass substrate layer 130n, in particular, the outer portion of the scoring line, may be removed, for example, by pressing an end portion of an upper surface of the overhang region in a downward direction, but is not limited thereto.

In some embodiments, a process of at least partially cooling down the glass substrate layer 130m may be further performed before removing the overhang region of the glass substrate layer 130m, e.g., the outer portion of the scoring line. For example, the scoring line and/or an adjacent portion of the scoring line of the glass substrate layer 130m may be cooled down to a temperature of about 0° C. or less. In some embodiments, liquid nitrogen may be sprayed to cool down the scoring line of the glass substrate layer 130m and/or the adjacent portion of the scoring line.

Referring to FIGS. 3 and 4E, a finishing process may be performed on the glass substrate layer 130n, the adhesive film 120, and the base material 110.

The finishing process is a process of partially removing the edge portion of the glass substrate layer 130n, in particular, the remaining overhang region, so that the glass substrate layer 130n may not protrude in the lateral direction of the base material 110. To this end, the remaining overhang region of the glass substrate layer 130n may be partially removed from the lateral direction thereof by, for example, a grinding, a brushing method, etc.

In particular, the glass substrate layer 130n may be finished to have the inclined side surface GSS as shown in FIG. 2. In some embodiments, the glass substrate layer 130n may be finished to have the features shown in FIG. 2.

Referring back to FIG. 2, the second side surface SS2 and the side surface GSS of the glass substrate layer 130 may be simultaneously formed. As a result, the second side surface SS2 and the side surface GSS of the glass substrate layer 130 may be substantially flush with each other. Even when the second side surface SS2 and the side surface GSS of the glass substrate layer 130 may not be flush with each other due to a momentary movement of the adhesive film 120 caused by temperature variation, a weight of the glass substrate layer 130, etc., the second side surface SS2 and the side surface GSS of the glass substrate layer 130 may be at least in parallel with each other.

Since the glass substrate layer 130n is close to a rigid body, it is easy to process the glass substrate layer 130n to have the inclined side surface GSS. However, since the adhesive film 120 includes a flexible matrix portion and adhesive components applied to opposite surfaces of the flexible matrix portion, it may be difficult to obtain a smooth inclined surface when processing the side surface of the glass substrate layer 130n in some cases. As stated above, at least the scoring line and/or the adjacent portion of the scoring line may be cooled down before performing the finishing process, and thus processability of the adhesive film 120 may be improved due to the cooling process and the smooth inclined surface may be obtained.

FIG. 7 is a cross-sectional view showing an edge of a glass laminate article according to another embodiment.

Referring to FIG. 7, a base material 110a may be obtained by bonding two different kinds of base materials, that is, first and second base materials 112 and 114. In some embodiments, the base material 110a may include a first base material 112 and a second base material 114 attached onto the first base material 112. In some embodiments, the adhesive film 120 may be attached to an upper surface of the second base material 114. In some embodiments, the second base material 114 may be arranged between the adhesive film 120 and the first base material 112. The second base material 114 may have a material having a higher strength than that of the first base material 112.

In some embodiments, the first base material 112 may include a non-metal base material, e.g., HPL, PCM, MDF, or VCM. However, one or more embodiments are not limited thereto.

In some embodiments, the second base material 114 may include metal. For example, the second base material 114 may include aluminum (Al), steel, stainless steel, copper (Cu), titanium (Ti), and other metal alloys. However, one or more embodiments are not limited thereto.

A first side surface SS1 of the base material 110a may include a first surface SS12 that is a side surface of the first base material 112 and a second surface SS14 that is a side surface of the second base material 114. In addition, a second side surface SS2 of the base material 110a may be located between an upper surface of the second base material 114 (that is, an upper surface US of the base material 110a) and the second surface SS14. In some embodiments, the first base material 112 may not include an inclined surface that is inclined with respect to a lower surface thereof (that is, a lower surface LS of the base material 110a).

As described above with reference to FIG. 2, the second side surface SS2 may be in parallel with the side surface GSS of the glass substrate layer 130. In some embodiments, the second side surface SS2 may be flush with the side surface GSS of the glass substrate layer 130.

As described above with reference to FIG. 4E, the second side surface SS2 and the side surface GSS of the glass substrate layer 130 may be simultaneously formed through the same process. Here, since the second base material 114 having a relatively higher strength is located between the first base material 112 and the glass substrate layer 130, a dimensional error caused when the first base material 112 is unintentionally damaged due to the grinding, etc. may be prevented.

According to the glass laminate article and the method of manufacturing the glass laminate article of one or more embodiments, the glass laminate article having an excellent appearance and safety may be easily manufactured with less expenses.

As described above, although the embodiments have been disclosed, one of ordinary skill in the art will appreciate that various modifications are possible, without departing from the scope and spirit of the inventive concept as disclosed in the accompanying claims. Therefore, all differences within the scope will be construed as being included in the inventive concept.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

1. A method of manufacturing a glass laminate article, the method comprising:
attaching an adhesive film onto a base material;
attaching a glass substrate layer onto the adhesive film, the glass substrate layer having an overhang region over edges of the base material;
performing scoring within the overhang region of the glass substrate layer;
removing the overhang region on an outer portion of a scored portion in the glass substrate layer; and
finishing a remaining overhang region of the glass substrate layer.

2. The method of claim 1, wherein a length of a protruding portion of the overhang region over the edges of the base material is 3 mm to 15 mm.

3. The method of claim 1, wherein, in the scoring, a distance between the edges of the base material and a scoring line is 1 mm or less, respectively.

4. The method of claim 1, wherein, in the scoring, the distance between the edges of the base material and a scoring line is 0.2 mm to 0.5 mm, respectively.

5. The method of claim 1, wherein the scoring comprises providing a supporter under the overhang region before scoring the glass substrate layer.

6. The method of claim 1, wherein the finishing of the remaining overhang region comprises removing the remaining overhang region by a grinding method.

7. The method of claim 6, wherein the finishing of the remaining overhang region is performed such that a side surface of the glass substrate layer is made to have an angle of 95° to 120° with respect to an upper surface of the glass substrate layer.

8. The method of claim 1, further comprising
cooling down a scoring line of the glass substrate layer to a temperature of 0° C. or less before the removing.

9. The method of claim 8, wherein the cooling down of the scoring line comprises spraying nitrogen.

10. A glass laminate article comprising:
an adhesive film attached to a base material; and
a glass substrate layer attached to the adhesive film,
wherein
the glass substrate layer has a side surface that is inclined with respect to an upper surface thereof by an obtuse angle.

11. The glass laminate article of claim 10, wherein the base material comprises:
a first side surface that is substantially perpendicular to an upper surface of the base material; and
a second side surface that is parallel with the side surface of the glass substrate layer, the second side surface being adjacent to the first side surface.

12. The glass laminate article of claim 11, wherein an angle between the second side surface and the upper surface of the base material is 95° to 120°.

13. The glass laminate article of claim 11, wherein a distance between an end portion of the upper surface of the glass substrate layer and the first side surface in a direction parallel with the upper surface of the glass substrate layer is 0.5 mm or less.

14. The glass laminate article of claim 11, wherein a side surface of the adhesive film is flush and continuous with the side surface of the glass substrate layer.

15. The glass laminate article of claim 14, wherein the side surface of the glass substrate layer, the side surface of the adhesive film, and the second side surface are successively adjacent to one another in the stated order and are flush with one another.

16. The glass laminate article of claim 11, wherein the base material comprises a metal base material stacked on a non-metal base material, and the metal base material is in contact with the adhesive film.
